(19) United States
(12) Patent Application Publication
(10) Pub. No.: US 2025/0245682 A1
(43) Pub. Date: Jul. 31, 2025

(54) SYSTEMS AND METHODS FOR SIMULATION OPTIMIZATION OF PRODUCTION NETWORKS

(71) Applicant: Walmart Apollo, LLC, Bentonville, AR (US)

(72) Inventors: Rama Durga Sekhar Angadala, Bentonville, AR (US); Samrat Nath, Fayetteville, AR (US); Van Tate Johansen, Bentonville, AR (US); Jeffin Valliyil Jacob, Centerton, AR (US); Parth Dhir, Uttar Pradesh (IN); Goutam Pradhan, Bengaluru (IN); Joel Alan Rutledge, Bentonville, AR (US); Devanand Chintoju, Hyderabad Telangana (IN); Martin V. Tabler, Rogers, AR (US)

(21) Appl. No.: 18/428,941

(22) Filed: Jan. 31, 2024

(51) Int. Cl. G06Q 30/0202; G06Q 10/04

(52) U.S. Cl. CPC G06Q 30/0202; G06Q 10/04

(57) ABSTRACT

Systems and methods of production network simulation optimization are disclosed. An optimization request identifying a target production node is received and an optimization engine is implemented to optimize a sequence of operation for one or more sub-nodes of the target production node. The optimization engine utilizes an objective function configured to maximize an adherence percentage. An optimized production data structure including the optimized sequence of operation of the one or more sub-nodes of the target production node is output.

### TECHNICAL FIELD

This application relates generally to simulation of production systems, and more particularly, to optimization of production processes for simulated production systems.

### BACKGROUND

Production planning and scheduling attempt to align raw material supply with demand efficiently. Current planning systems rely on integration of data points, a manual and time consuming process. Due to time constraints, current production planning systems are limited to a day-by-day basis, preventing long-term optimization.

Some current planning systems utilize static, rule-based heuristic systems to generate linear production plans with linear constraints. Such systems rely on linear models for stochastic features and events and thus do not provide future visibility feedback. In addition, these systems generate only same-day schedules utilizing static constraints and do not provide simulation tools to adjust a simulation in response to dynamic events or external occurrences. Current systems also fail to provide predictive capacity information.

### SUMMARY

In various embodiments, a system include a non-transitory memory and a processor communicatively coupled to the non-transitory memory is disclosed. The processor is configured to read a set of instructions to receive an optimization request identifying a target production node, implement an optimization engine configured to optimize a sequence of operation for one or more sub-nodes of the target production node utilizing an objective function configured to maximize an adherence percentage, and output an optimized production data structure including the optimized sequence of operation of the one or more sub-nodes of the target production node.

In various embodiments, a computer-implemented method is disclosed. The computer-implemented method includes steps of receiving an optimization request identifying a target production node, implementing an optimization engine configured to optimize a sequence of operation for one or more sub-nodes of the target production node utilizing an objective function configured to maximize an adherence percentage, and outputting an optimized production data structure including the optimized sequence of operation of the one or more sub-nodes of the target production node.

In various embodiments, a non-transitory computer readable medium having instructions stored thereon is disclosed. The instructions, when executed by at least one processor, cause at least one device to perform operations including receiving an optimization request identifying a target production node and implementing an optimization engine configured to optimize a sequence of operation for one or more sub-nodes of the target production node utilizing an objective function configured to maximize an adherence percentage. The objective function is configured to optimize a plurality of parameters including a final resource type, a final resource quantity, a production timeframe, and a sub-node selection. The instructions further cause the device to perform operations including outputting an optimized production data structure including the optimized sequence of operation of the one or more sub-nodes of the target production node.

### BRIEF DESCRIPTION OF THE DRAWINGS

The features and advantages of the present invention will be more fully disclosed in, or rendered obvious by the following detailed description of the preferred embodiments, which are to be considered together with the accompanying drawings wherein like numbers refer to like parts and further wherein:

FIG. 1 illustrates a network environment configured to production optimization of a target network, in accordance with some embodiments;

FIG. 2 illustrates a computer system configured to implement one or more processes, in accordance with some embodiments;

FIG. 3 is a flowchart illustrating a production optimization method, in accordance with some embodiments;

FIG. 4 is a process flow illustrating various steps of the production optimization method of FIG. 3 as applied to a simulated network, in accordance with some embodiments;

FIG. 5 illustrates a graph representation of an example target network, in accordance with some embodiments;

FIG. 6 illustrates a graph representation of an example target network, in accordance with some embodiments;

FIG. 7 illustrates an artificial neural network, in accordance with some embodiments;

FIG. 8 illustrates a deep neural network (DNN), in accordance with some embodiments;

FIG. 9 is a flowchart illustrating a training method for generating a trained machine learning model, in accordance with some embodiments; and

FIG. 10 is a process flow illustrating various steps of the training method of FIG. 9, in accordance with some embodiments.

### DETAILED DESCRIPTION

This description of the exemplary embodiments is intended to be read in connection with the accompanying drawings, which are to be considered part of the entire written description. Terms concerning data connections, coupling and the like, such as “connected” and “interconnected,” and/or “in signal communication with” refer to a relationship wherein systems or elements are electrically connected (e.g., wired, wireless, etc.) to one another either directly or indirectly through intervening systems, unless expressly described otherwise. The term “operatively coupled” is such a coupling or connection that allows the pertinent structures to operate as intended by virtue of that relationship.

In the following, various embodiments are described with respect to the claimed systems as well as with respect to the claimed methods. Features, advantages, or alternative embodiments herein may be assigned to the other claimed objects and vice versa. In other words, claims for the systems may be improved with features described or claimed in the context of the methods. In this case, the functional features of the method are embodied by objective units of the systems. While the present disclosure is susceptible to various modifications and alternative forms, specific embodiments are shown by way of example in the drawings and will be described in detail herein. The objectives and advantages of the claimed subject matter will become more apparent from the following detailed description of these exemplary embodiments in connection with the accompanying drawings.

Furthermore, in the following, various embodiments are described with respect to methods and systems for optimization of simulated production planning and scheduling networks. In various embodiments, the disclosed systems and methods are configured to optimize a simulated network to meet one or more criteria, such as, for example, production-related criteria such as “On Time In Full” (“OTIF”) production criteria. OTIF target rates may be optimized within a network for one or more nodes, such as distribution nodes and/or demand nodes.

In some embodiments, systems and methods for optimization of simulated production planning and scheduling networks are configured to generate an optimal simulation solutions for utilization of production resources within a target network. Production resources may include, but are not limited to, node production capacity, line production capacity, initial resource inventory, initial resource yield, by-product utilization, etc. In some embodiments, the systems and methods for optimization of simulated production planning and scheduling networks are configured to output optimal input requirements, e.g., optimal initial resource requirements, for operation of the target network at optimized production levels for a given time period.

In some embodiments, the systems and methods for optimization of simulated production planning and scheduling networks utilize an optimization model including a genetic algorithm configured to receive input from one or more upstream models and/or inputs, such as, for example, one or more prediction models, one or more historical aggregation models, network parameter inputs, etc. The optimization model may be configured to implement a multidimensional solution configured to optimize for multiple dimensions, such as optimizing for one or more predetermined time periods (e.g., one or more days, one or more hours, one or more weeks, etc.), one or more production mechanisms (e.g., one or more production facilities, one or more production lines, etc.), and/or one or more production options (e.g., one or more potential output products). Although certain embodiments are discussed herein, it will be appreciated that the disclosed systems and methods may be used to optimize a production network for any selected parameters.

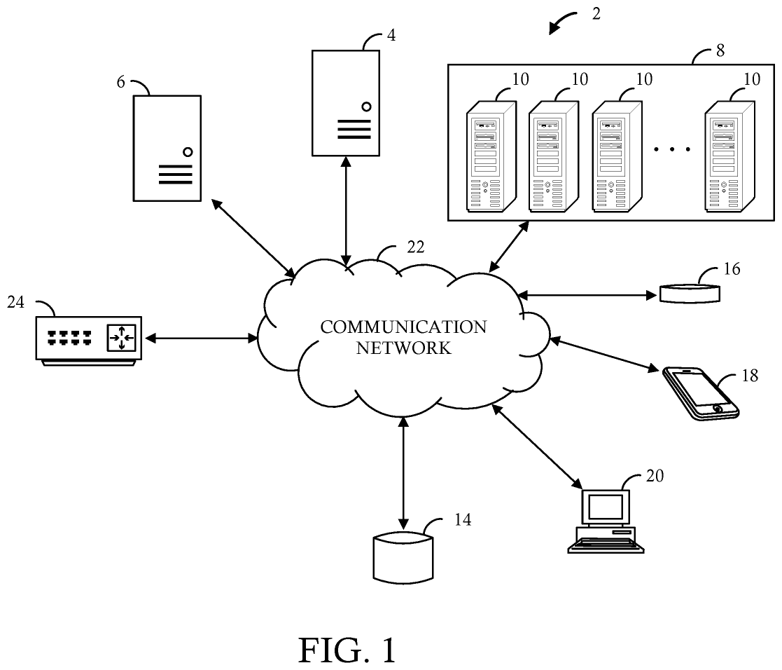

FIG. 1 illustrates a network environment 2 configured to provide production optimization of a target network, in accordance with some embodiments. The network environment 2 includes a plurality of devices or systems configured to communicate over one or more network channels, illustrated as a network cloud 22. For example, in various embodiments, the network environment 2 may include, but is not limited to, an optimization computing device 4, a web server 6, a cloud-based engine 8 including one or more processing devices 10, one or more workstations 12, a database 14, and/or one or more user computing devices 16, 18, 20 operatively coupled over the network 22. The optimization computing device 4, the web server 6, the processing device(s) 10, the workstations, and/or the user computing devices 16, 18, 20 may each be a suitable computing device that includes any hardware or hardware and software combination for processing and handling information. For example, each computing device may include, but is not limited to, one or more processors, one or more field-programmable gate arrays (FPGAs), one or more application-specific integrated circuits (ASICs), one or more state machines, digital circuitry, and/or any other suitable circuitry. In addition, each computing device may transmit and receive data over the communication network 22.

In some embodiments, each of the optimization computing device 4 and the processing device(s) 10 may be a computer, a workstation, a laptop, a server such as a cloud-based server, or any other suitable device. In some embodiments, each of the processing devices 10 is a server that includes one or more processing units, such as one or more graphical processing units (GPUs), one or more central processing units (CPUs), and/or one or more processing cores. Each processing device 10 may, in some embodiments, execute one or more virtual machines. In some embodiments, processing resources (e.g., capabilities) of the one or more processing devices 10 are offered as a cloud-based service (e.g., cloud computing). For example, the cloud-based engine 8 may offer computing and storage resources of the one or more processing devices 10 to the optimization computing device 4.

In some embodiments, each of the user computing devices 16, 18, 20 may be a cellular phone, a smart phone, a tablet, a personal assistant device, a voice assistant device, a digital assistant, a laptop, a computer, or any other suitable device. In some embodiments, the web server 6 hosts one or more network environments, such as an e-commerce network environment. In some embodiments, the optimization computing device 4, the processing devices 10, and/or the web server 6 are operated by the network environment provider, and the user computing devices 16, 18, 20 are operated by users of the network environment. In some embodiments, the processing devices 10 are operated by a third party (e.g., a cloud-computing provider).

In some embodiments, one or more of the network devices are operably coupled to the communication network 22 via a router 24 and one or more network devices may be located at a physical location 26 remote from one or more other network devices. In some embodiments, one or more workstation(s) 12 may send data to, and receive data from, the optimization computing device 4. For example, the workstation(s) 12 may transmit data related to tracked operations performed at the physical location 26, generate inputs for use in simulation of a target network, and/or otherwise provide date to the to optimization computing device 4.

Although FIG. 1 illustrates three user computing devices 16, 18, 20, the network environment 2 may include any number of user computing devices 16, 18, 20. Similarly, the network environment 2 may include any number of the optimization computing device 4, the web server 6, the processing devices 10, the workstation(s) 12, the database 14, the router 24, etc. It will further be appreciated that additional systems, servers, storage mechanism, etc. may be included within the network environment 2. In addition, although embodiments are illustrated herein having individual, discrete systems, it will be appreciated that, in some embodiments, one or more systems may be combined into a single logical and/or physical system. For example, in various embodiments, one or more of the optimization computing device 4, the web server 6, the workstation(s) 12, the database 14, the user computing devices 16, 18, 20, and/or the router 24 may be combined into a single logical and/or physical system. Similarly, although embodiments are illustrated having a single instance of each device or system, it will be appreciated that additional instances of a device may be implemented within the network environment 2. In some embodiments, two or more systems may be operated on shared hardware in which each system operates as a separate, discrete system utilizing the shared hardware, for example, according to one or more virtualization schemes.

The communication network 22 may be a WiFi® network, a cellular network such as a 3GPP® network, a Bluetooth® network, a satellite network, a wireless local area network (LAN), a network utilizing radio-frequency (RF) communication protocols, a Near Field Communication (NFC) network, a wireless Metropolitan Area Network (MAN) connecting multiple wireless LANs, a wide area network (WAN), or any other suitable network. The communication network 22 may provide access to, for example, the Internet.

Each of the user computing devices 16. 18, 20 may communicate with the web server 6 over the communication network 22. For example, each of the user computing devices 16, 18, 20 may be operable to view, access, and interact with a website, such as a simulation website, hosted by the web server 6. The web server 6 may transmit session data to the simulation computing device 4 over the communication network 22. The website may also allow the user to interact with one or more interface elements to perform specific operations, such as selecting one or more parameters for simulation of a target network.

In some embodiments, the optimization computing device 4 may execute one or more models, processes, or algorithms, such as a machine learning model, deep learning model, statistical model, optimization model, genetic algorithm, etc., to optimize production within a simulated target network. For example, in some embodiments, the optimization computing device 4 is configured to optimize a target network to meet one or more OTIF targets and/or requirements. The optimization computing device 4 may transmit optimization and/or simulation results to the web server 6 over the communication network 22, and the web server 6 may display interface elements associated with the optimization and/or simulation results on the website to the user. For example, the web server 6 may display interface elements associated with simulation inputs, target outputs, simulation outputs, etc. to the user on a generated interface page.

The optimization computing device 4 is further operable to communicate with the database 14 over the communication network 22. For example, the optimization computing device 4 may store data to, and read data from, the database 14. The database 14 may be a remote storage device, such as a cloud-based server, a disk (e.g., a hard disk), a memory device on another application server, a networked computer, or any other suitable remote storage. Although shown remote to the optimization computing device 4, in some embodiments, the database 14 may be a local storage device, such as a hard drive, a non-volatile memory, or a USB stick. The optimization computing device 4 may store interaction data received from the web server 6 in the database 14. The optimization computing device 4 may also receive from the web server 6 user session data identifying events associated with browsing sessions, and may store the user session data in the database 14.

In some embodiments, the optimization computing device 4 generates training data for a plurality of models (e.g., machine learning models, deep learning models, statistical models, algorithms, etc.) based on simulation and/or historical network data. The optimization computing device 4 and/or one or more of the processing devices 10 may train one or more models based on corresponding training data. The generated models may be stores in a database, such as in the database 14 (e.g., a cloud storage database).

In general, a trained machine learning function mimics cognitive functions that humans associate with other human minds. In particular, by training based on training data the trained function is able to adapt to new circumstances and to detect and extrapolate patterns. Parameters of a trained machine learning function may be adapted by means of training. In particular, a combination of supervised training, semi-supervised training, unsupervised training, reinforcement learning and/or active learning may be used. Furthermore, representation learning (an alternative term is “feature learning”) may be used. In particular, the parameters of the trained functions may be adapted iteratively by several steps of training.

The models, when executed by a device, such as the optimization computing device 4, allow the optimization computing device 4 to generate simulation inputs, simulate operation of one or more aspects of a target network, and/or generate one or more outputs. For example, the optimization computing device 4 may obtain one or more models from the database 14. The optimization computing device 4 may execute the one or more models to generate one or more upstream inputs for incorporation into a simulation of a target network. As another example, the optimization computing device 4 may execute the one or more models to optimize for one or more target parameters, e.g., one or more OTIF targets, during simulated operation of the target network.

In some embodiments, execution of one or more of the models (or parts thereof) is assigned to one or more processing devices 10. For example, each model may be assigned to a virtual machine hosted by a processing device 10. The virtual machine may cause the models or parts thereof to execute on one or more processing units such as GPUs. In some embodiments, the virtual machines assign each model (or part thereof) among a plurality of processing units. Based on the output of the models, the optimization computing device 4 may simulate operation of a target network, generate outputs for simulation of the target network, and/or simulate one or more portions of a target network.

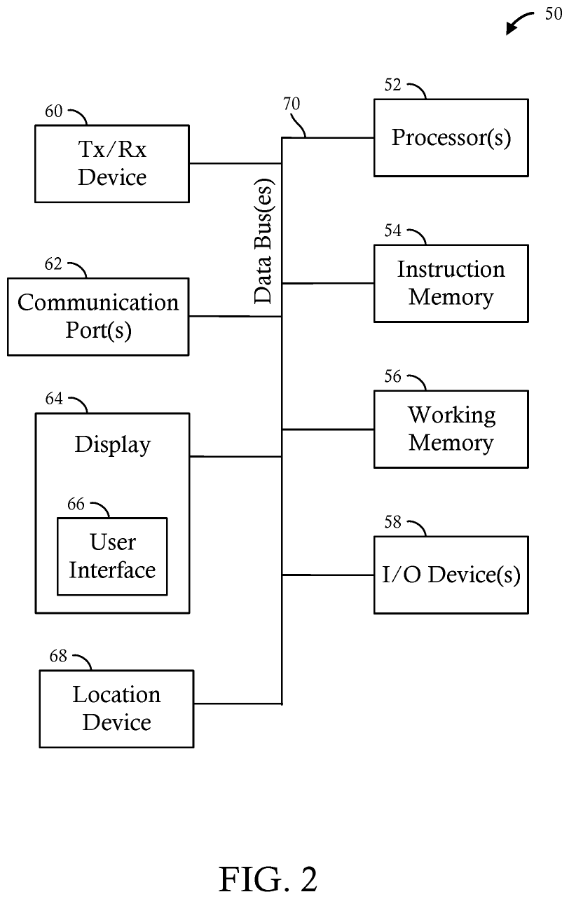

FIG. 2 illustrates a block diagram of a computing device 50, in accordance with some embodiments. In some embodiments, each of the optimization computing device 4, the web server 6, the one or more processing devices 10, the workstation(s) 12, and/or the user computing devices 16, 18, 20 in FIG. 1 may include the features shown in FIG. 2. Although FIG. 2 is described with respect to certain components shown therein, it will be appreciated that the elements of the computing device 50 may be combined, omitted, and/or replicated. In addition, it will be appreciated that additional elements other than those illustrated in FIG. 2 may be added to the computing device.

As shown in FIG. 2, the computing device 50 may include one or more processors 52, an instruction memory 54, a working memory 56, one or more input/output devices 58, a transceiver 60, one or more communication ports 62, a display 64 with a user interface 66, and an optional location device 68, all operatively coupled to one or more data buses 70. The data buses 70 allow for communication among the various components. The data buses 70 may include wired, or wireless, communication channels.

The one or more processors 52 may include any processing circuitry operable to control operations of the computing device 50. In some embodiments, the one or more processors 52 include one or more distinct processors, each having one or more cores (e.g., processing circuits). Each of the distinct processors may have the same or different structure. The one or more processors 52 may include one or more central processing units (CPUs), one or more graphics processing units (GPUs), application specific integrated circuits (ASICs), digital signal processors (DSPs), a chip multiprocessor (CMP), a network processor, an input/output (I/O) processor, a media access control (MAC) processor, a radio baseband processor, a co-processor, a microprocessor such as a complex instruction set computer (CISC) microprocessor, a reduced instruction set computing (RISC) microprocessor, and/or a very long instruction word (VLIW) microprocessor, or other processing device. The one or more processors 52 may also be implemented by a controller, a microcontroller, an application specific integrated circuit (ASIC), a field programmable gate array (FPGA), a programmable logic device (PLD), etc.

In some embodiments, the one or more processors 52 are configured to implement an operating system (OS) and/or various applications. Examples of an OS include, for example, operating systems generally known under various trade names such as Apple macOS™, Microsoft Windows™, Android™, Linux™, and/or any other proprietary or open-source OS. Examples of applications include, for example, network applications, local applications, data input/output applications, user interaction applications, etc.

The instruction memory 54 may store instructions that are accessed (e.g., read) and executed by at least one of the one or more processors 52. For example, the instruction memory 54 may be a non-transitory, computer-readable storage medium such as a read-only memory (ROM), an electrically erasable programmable read-only memory (EEPROM), flash memory (e.g. NOR and/or NAND flash memory), content addressable memory (CAM), polymer memory (e.g., ferroelectric polymer memory), phase-change memory (e.g., ovonic memory), ferroelectric memory, silicon-oxide-nitride-oxide-silicon (SONOS) memory, a removable disk, CD-ROM, any non-volatile memory, or any other suitable memory. The one or more processors 52 may be configured to perform a certain function or operation by executing code, stored on the instruction memory 54, embodying the function or operation. For example, the one or more processors 52 may be configured to execute code stored in the instruction memory 54 to perform one or more of any function, method, or operation disclosed herein.

Additionally, the one or more processors 52 may store data to, and read data from, the working memory 56. For example, the one or more processors 52 may store a working set of instructions to the working memory 56, such as instructions loaded from the instruction memory 54. The one or more processors 52 may also use the working memory 56 to store dynamic data created during one or more operations. The working memory 56 may include, for example, random access memory (RAM) such as a static random access memory (SRAM) or dynamic random access memory (DRAM), Double-Data-Rate DRAM (DDR-RAM), synchronous DRAM (SDRAM), an EEPROM, flash memory (e.g. NOR and/or NAND flash memory), content addressable memory (CAM), polymer memory (e.g., ferroelectric polymer memory), phase-change memory (e.g., ovonic memory), ferroelectric memory, silicon-oxide-nitride-oxide-silicon (SONOS) memory, a removable disk, CD-ROM, any non-volatile memory, or any other suitable memory. Although embodiments are illustrated herein including separate instruction memory 54 and working memory 56, it will be appreciated that the computing device 50 may include a single memory unit configured to operate as both instruction memory and working memory. Further, although embodiments are discussed herein including non-volatile memory, it will be appreciated that computing device 50 may include volatile memory components in addition to at least one non-volatile memory component.

In some embodiments, the instruction memory 54 and/or the working memory 56 includes an instruction set, in the form of a file for executing various methods, such as methods for production optimization of a target network, as described herein. The instruction set may be stored in any acceptable form of machine-readable instructions, including source code or various appropriate programming languages. Some examples of programming languages that may be used to store the instruction set include, but are not limited to: Java, JavaScript, C, C++, C#, Python, Objective-C, Visual Basic, .NET, HTML, CSS, SQL, NoSQL, Rust, Perl, etc. In some embodiments a compiler or interpreter is configured to convert the instruction set into machine executable code for execution by the one or more processors 52.

The input-output devices 58 may include any suitable device that allows for data input or output. For example, the input-output devices 58 may include one or more of a keyboard, a touchpad, a mouse, a stylus, a touchscreen, a physical button, a speaker, a microphone, a keypad, a click wheel, a motion sensor, a camera, and/or any other suitable input or output device.

The transceiver 60 and/or the communication port(s) 62 allow for communication with a network, such as the communication network 22 of FIG. 1. For example, if the communication network 22 of FIG. 1 is a cellular network, the transceiver 60 is configured to allow communications with the cellular network. In some embodiments, the transceiver 60 is selected based on the type of the communication network 22 the computing device 50 will be operating in. The one or more processors 52 are operable to receive data from, or send data to, a network, such as the communication network 22 of FIG. 1, via the transceiver 60.

The communication port(s) 62 may include any suitable hardware, software, and/or combination of hardware and software that is capable of coupling the computing device 50 to one or more networks and/or additional devices. The communication port(s) 62 may be arranged to operate with any suitable technique for controlling information signals using a desired set of communications protocols, services, or operating procedures. The communication port(s) 62 may include the appropriate physical connectors to connect with a corresponding communications medium, whether wired or wireless, for example, a serial port such as a universal asynchronous receiver/transmitter (UART) connection, a Universal Serial Bus (USB) connection, or any other suitable communication port or connection. In some embodiments, the communication port(s) 62 allows for the programming of executable instructions in the instruction memory 54. In some embodiments, the communication port(s) 62 allow for the transfer (e.g., uploading or downloading) of data, such as machine learning model training data.

In some embodiments, the communication port(s) 62 are configured to couple the computing device 50 to a network. The network may include local area networks (LAN) as well as wide area networks (WAN) including without limitation Internet, wired channels, wireless channels, communication devices including telephones, computers, wire, radio, optical and/or other electromagnetic channels, and combinations thereof, including other devices and/or components capable of/associated with communicating data. For example, the communication environments may include in-body communications, various devices, and various modes of communications such as wireless communications, wired communications, and combinations of the same.

In some embodiments, the transceiver 60 and/or the communication port(s) 62 are configured to utilize one or more communication protocols. Examples of wired protocols may include, but are not limited to, Universal Serial Bus (USB) communication, RS-232, RS-422, RS-423, RS-485 serial protocols, FireWire, Ethernet, Fibre Channel, MIDI, ATA, Serial ATA, PCI Express, T-1 (and variants), Industry Standard Architecture (ISA) parallel communication, Small Computer System Interface (SCSI) communication, or Peripheral Component Interconnect (PCI) communication, etc. Examples of wireless protocols may include, but are not limited to, the Institute of Electrical and Electronics Engineers (IEEE) 802.xx series of protocols, such as IEEE 802.11a/b/g/n/ac/ag/ax/be, IEEE 802.16, IEEE 802.20, GSM cellular radiotelephone system protocols with GPRS, CDMA cellular radiotelephone communication systems with 1×RTT, EDGE systems, EV-DO systems, EV-DV systems, HSDPA systems, Wi-Fi Legacy, Wi-Fi 1/2/3/4/5/6/6E, wireless personal area network (PAN) protocols, Bluetooth Specification versions 5.0, 6, 7, legacy Bluetooth protocols, passive or active radio-frequency identification (RFID) protocols, Ultra-Wide Band (UWB), Digital Office (DO), Digital Home, Trusted Platform Module (TPM), ZigBee, etc.

The display 64 may be any suitable display, and may display the user interface 66. The user interfaces 66 may enable user interaction with simulation inputs and/or results. For example, the user interface 66 may be a user interface for an application of a network environment operator that allows a user to view and interact with the operator's website. In some embodiments, a user may interact with the user interface 66 by engaging the input-output devices 58. In some embodiments, the display 64 may be a touchscreen, where the user interface 66 is displayed on the touchscreen.

The display 64 may include a screen such as, for example, a Liquid Crystal Display (LCD) screen, a light-emitting diode (LED) screen, an organic LED (OLED) screen, a movable display, a projection, etc. In some embodiments, the display 64 may include a coder/decoder, also known as Codecs, to convert digital media data into analog signals. For example, the visual peripheral output device may include video Codecs, audio Codecs, or any other suitable type of Codec.

The optional location device 68 may be communicatively coupled to a location network and operable to receive position data from the location network. For example, in some embodiments, the location device 68 includes a GPS device configured to receive position data identifying a latitude and longitude from one or more satellites of a GPS constellation. As another example, in some embodiments, the location device 68 is a cellular device configured to receive location data from one or more localized cellular towers. Based on the position data, the computing device 50 may determine a local geographical area (e.g., town, city, state, etc.) of its position.

In some embodiments, the computing device 50 is configured to implement one or more modules or engines, each of which is constructed, programmed, configured, or otherwise adapted, to autonomously carry out a function or set of functions. A module/engine may include a component or arrangement of components implemented using hardware, such as by an application specific integrated circuit (ASIC) or field-programmable gate array (FPGA), for example, or as a combination of hardware and software, such as by a microprocessor system and a set of program instructions that adapt the module/engine to implement the particular functionality, which (while being executed) transform the microprocessor system into a special-purpose device. A module/engine may also be implemented as a combination of the two, with certain functions facilitated by hardware alone, and other functions facilitated by a combination of hardware and software. In certain implementations, at least a portion, and in some cases, all, of a module/engine may be executed on the processor(s) of one or more computing platforms that are made up of hardware (e.g., one or more processors, data storage devices such as memory or drive storage, input/output facilities such as network interface devices, video devices, keyboard, mouse or touchscreen devices, etc.) that execute an operating system, system programs, and application programs, while also implementing the engine using multitasking, multithreading, distributed (e.g., cluster, peer-peer, cloud, etc.) processing where appropriate, or other such techniques. Accordingly, each module/engine may be realized in a variety of physically realizable configurations, and should generally not be limited to any particular implementation exemplified herein, unless such limitations are expressly called out. In addition, a module/engine may itself be composed of more than one sub-modules or sub-engines, each of which may be regarded as a module/engine in its own right. Moreover, in the embodiments described herein, each of the various modules/engines corresponds to a defined autonomous functionality; however, it should be understood that in other contemplated embodiments, each functionality may be distributed to more than one module/engine. Likewise, in other contemplated embodiments, multiple defined functionalities may be implemented by a single module/engine that performs those multiple functions, possibly alongside other functions, or distributed differently among a set of modules/engines than specifically illustrated in the embodiments herein.

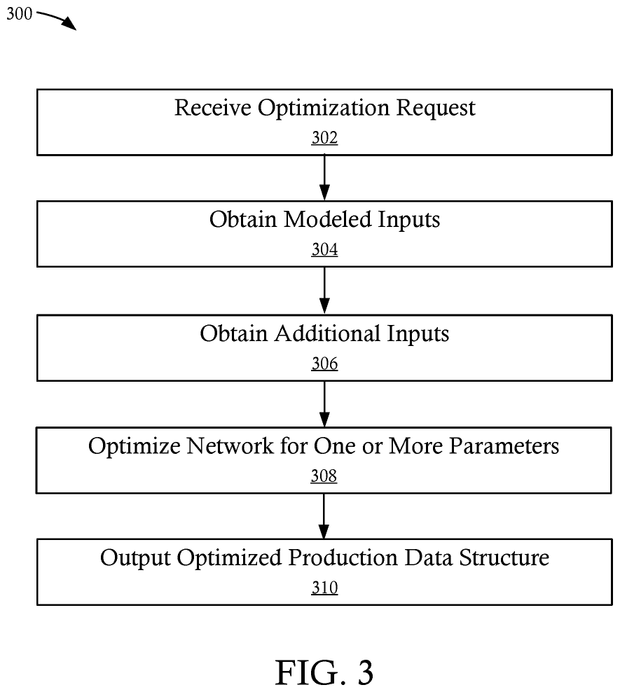

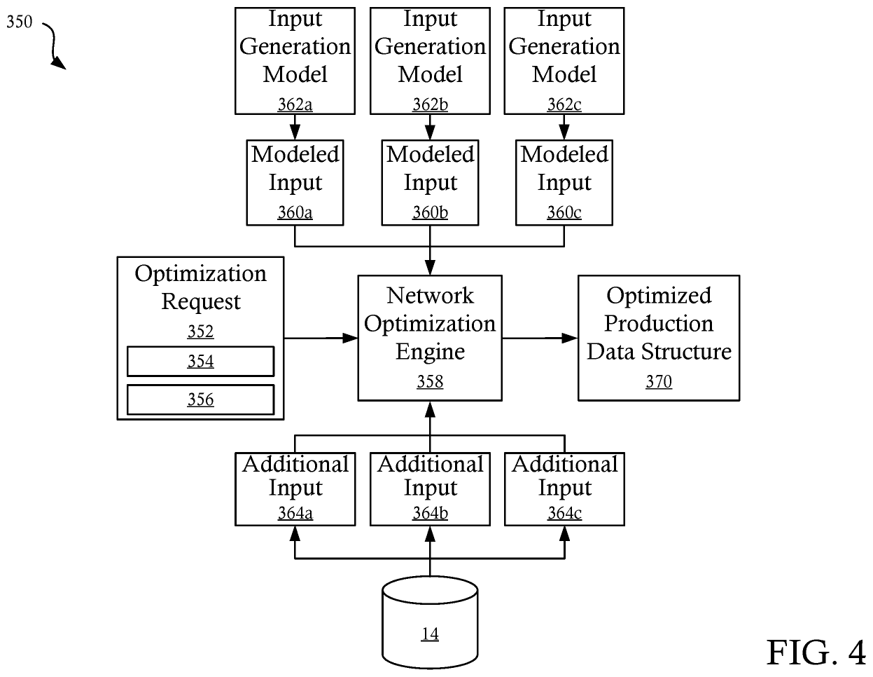

FIG. 3 is a flowchart illustrating a production optimization method 300, in accordance with some embodiments. FIG. 4 is a process flow illustrating various steps of the production optimization method 300 as applied to a target network, in accordance with some embodiments. The production optimization method 300 may be applied periodically and/or dynamically to generate optimized production simulation outputs, e.g., optimized input requirements, optimized allocation of network resource, etc., to obtain one or more target outputs, e.g., one or more OTIF parameters, of the target network.

At step 302, an optimization request 352 is received. The optimization request 352 may be generated by any suitable system or device and received by any suitable system or device configured to implement at least a portion of the production optimization method 300. For example, in some embodiments, the optimization request 352 may be generated by a web server 6, a workstation 12, and/or a user computing device 16, 18, 20 and received by the optimization computing device 4 and/or one or more of the processing devices 10. In some embodiments, a network optimization engine 358 implemented by the receiving device, e.g., the optimization computing device 4, is configured to receive the optimization request 352.

In some embodiments, the optimization request 352 includes network data 354 defining and/or identifying a target production network and/or a target production node. For example, in some embodiments, the network data 354 includes an in-memory representation of a target production network. As another example, in some embodiments, the network data 354 includes an identifier utilized by the network optimization engine 358 to retrieve an in-memory representation of a target production network from a data source, such as database 14. As yet another example, in some embodiments, the network data 354 includes one or more parameters and/or identifiers to configure the network optimization engine 358 to generate an in-memory representation of a target production network. Although specific embodiments are discussed herein, it will be appreciated that any suitable process and/or method may be used to obtain an in-memory representation of a target production network as part of a product optimization method 300.

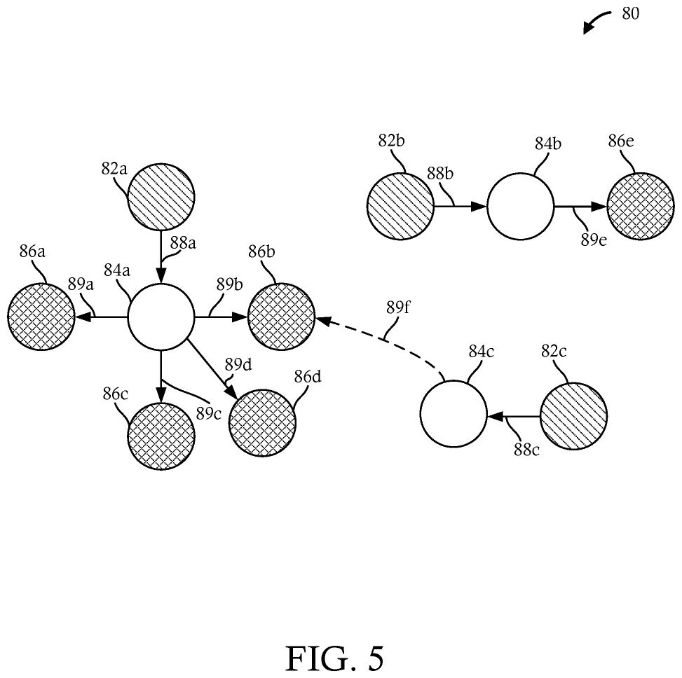

FIG. 5 illustrates a graph representation of an example target production network 80, in accordance with some embodiments. The graph representation of the target production network 80 includes a multipartite graph including a plurality of supply nodes 82a-82c (collectively “supply nodes 82”), a plurality of production nodes 84a-84c (collectively “production nodes 84”), a plurality of demand nodes 86a-86e (collectively “demand nodes 86”), a plurality of supply distribution channels 88a-88c (collectively “supply distribution channels 88”), and a plurality of production distribution channels 89a-89f (collectively “production distribution channels 89”). Each of the supply nodes 82 represents a supply source within the target production network 80 that provides one or more raw (e.g., initial) resources to one or more of the production nodes 84. Each of the production nodes 84 represent a processing element within the network that converts the one or more initial resources into one or more finished (e.g., final) resources. The production nodes 84 are configured to service demand of the finished resources within the target production network 80 and each of the demand nodes 86 represent a demand element within the target production network 80 that consume the finished resources.

In some embodiments, each of the supply nodes 82 is connected to at least one of the production nodes 84 by one or more of the supply distribution channels 88. Similarly, each of the demand nodes 86 are connected to at least one of the production nodes by one or more of the production distribution channels 89. In some embodiments, a production node, e.g., first production node 84a, may receive initial resources from two or more supply nodes, e.g., first supply node 82a and second supply node 82b. Similarly, a demand node, e.g., first demand node 86b, may receive finished resources from two or more production nodes, e.g., first production node 84a and third production node 84c. Although specific embodiments are discussed herein, it will be appreciated that any suitable target production network 80 may be optimized by the disclosed systems and methods. In some embodiments, the target production network 80 may be representative of a physical resource production network including multiple, geographically distributed supply nodes 82, production nodes 84, and/or demand nodes 86, such as, for example, a production network configured to generate one or more perishable finished products.

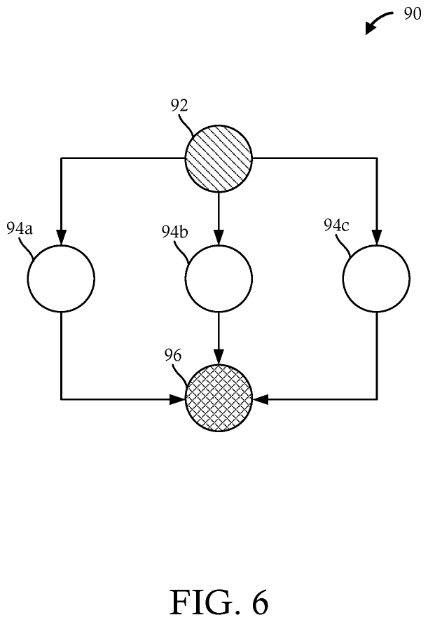

FIG. 6 illustrates a graph representation of an example target production node 90, in accordance with some embodiments. The target production node 90 includes a sub-network including a source node 92, a plurality of production sub-nodes 94a-94c (collectively “production sub-nodes 94”), and a distribution node 96. The source node 92 represents a supply source for the target production node 90 that aggregates all received initial (e.g., raw, partially processed, etc.) resources provided to the target production node 90. The source node 92 may represent initial resources received from one or nodes outside of the target production node 90, such as, for example, one or more of the supply nodes 82 of FIG. 5. Each of the production sub-nodes 94a represents a processing mechanism (e.g., processing line) of the target production node 90 that converts the one or more initial resources into one or more final (e.g., finished, intermediate, etc.) resources. The output of the production sub-nodes 94 are aggregated by a centralized distribution node 96 representative of an output distribution of finished resources from the target production node 90. The finished resources may be provided from to one or more demand nodes, such as one or more of the demand nodes 86 illustrated in FIG. 5. In some embodiments, the target production node 90 is representative of a production facility and/or system and each of the production sub-nodes 94 is representative of portion of the production facility (e.g., production line) operated within and/or by the production facility.

With reference again to FIGS. 3-5, in some embodiments, the network data 354 may include one or more node features and/or parameters representative of a resource provided by, generated by, and/or consumed by a corresponding node in a target network. For example, in some embodiments, each of the supply nodes 82 provides one or more initial resources to one or more of the production nodes 84. As another example, in some embodiments, each of the production nodes 84 includes one or more parameters defining finished resource production capacity. Although specific embodiments are discussed herein, it will be appreciated that the network data 354 may define any suitable parameters of any of the nodes within a target network.

In some embodiments, the optimization request 352 may include parameter data 356 defining target and/or operational parameters, constraints, costs, etc. for optimization and/or simulation of a target network. For example, in some embodiments, the parameter data 356 includes one or more production targets for operation of a target production node 90. The parameter data 356 may include simulation-defining parameters such as demand generation parameters (e.g., parameters related to the demand to be simulated), constraint parameters (e.g., parameters constraining the simulation or the system during simulation), etc. The parameter data 356 may additionally and/or alternatively include parameters defining one or more operational targets for a target production node 90. Operational targets may include target output(s) for one or more final resources. For example, a target output of a final resource from a target production node 90 may correspond to a network parameter defining demand for a corresponding final resource at one or more demand nodes 86. Although specific embodiments are discussed herein, it will be appreciated that any suitable input parameters, such as required or optional parameters, for the simulation can be included in the parameter data 356.

At step 304, one or more modeled inputs 360a-360c (collectively “modeled inputs 360”) are obtained. The modeled inputs 360 may include one or more modeled (e.g., simulated) input values. For example, in some embodiments, modeled inputs 360 may include one or more node parameters such as initial resource availability forecasts, capacity estimation values, finished resource demand forecasts, etc. The modeled inputs 360 may each be generated by a corresponding input generation model 362a-362c (collectively “input generation models 362”). Each of the input generation models 362 may include a trained model configured to generate (e.g., predict) values for the corresponding input. The input generation models 362 may include, but are not limited to, initial material availability forecast models, demand forecast models, capacity estimation models, etc.

The input generation models 362 may be configured to receive at least a portion of the parameter data 356. For example, in some embodiments, parameter data 356 may include, but is not limited to, historical data representative of actual performance or operation of the target network during a prior time period, real-time data representative of current conditions or operation of the target network, and/or predicted values for each of the input generation models 362. The one or more input generation models 362 may include, but are not limited to, machine learning based models, historical based models, statistical processes, etc. The input generation models 362 may be configured to provide any suitable predicted inputs, such as, for example, initial resource inventory, final resource inventory, conversion mappings for initial resource to final resource, etc. Multiple, different input generation models 362 may be executed simultaneously, sequentially, and/or intermittently to generate required inputs for a simulation.

In some embodiments, initial inputs to one or more of the input generation models 362 may be provided by monitoring one or more locations within a target network, such as, for example, monitoring one or more real-time and/or historical data sources within a target production node. For example, in some embodiments, a first input generation model 362a includes a final resource production rate model configured to receive historical data to generate a prediction of time of operation for generation of one or more final resources. As another example, in some embodiments, a second input generation model 362b includes a production capacity estimation model configured to utilize historical data to predict availability (e.g., up-time) for a target production node and/or a sub-node. As yet another example, in some embodiments, a third input generation model 362c includes a changeover estimation model configured to utilize historical data to estimate time between converting a sub-node from producing a first final resource to a second final resource. As still another example, in some embodiments, an input generation model may include an initial resource yield forecasting model.

At step 306, one or more additional inputs 364a-364c (collectively “additional inputs 364”) may be obtained (e.g., received, generated, etc.). The additional inputs 364 may include static inputs and/or variable inputs. In some embodiments, the additional inputs 364 are non-modeled inputs (e.g., known values, predetermined values, required values, etc.). In some embodiments, one or more of the additional inputs 364 may be generated based on at least a portion of the parameter data 356. For example, in some embodiments, the network parameters include initial resource information (e.g., a bill of materials (“BOM”)) configured to define raw material availability and/or usage, such as, for example, all combinations of semi-finished resources and/or finished resources that may be generated from a given initial resource and each of the options for processing the initial resource into each of the potential combinations of semi-finished and/or finished resources. In some embodiments, one or more additional inputs 364 may define additional parameters such as initial resource processing patterns, initial resource yields, line mappings, short term and/or long-term demand forecasts for planned initial resources and/or semi-finished final products being provided by one or more source nodes.

In some embodiments, the set of inputs 360, 364 may include input received from any suitable input location, such as, for example, aggregated data sources, sensors other internet of things (IoT) devices, forecasting model outputs, capacity model outputs, etc. Each of the inputs may be provided to allow for estimation of initial resource and/or final resource quantities, short-term and/or long-term forecasts or estimates, node operational parameters (e.g., production hours, production rates, change over times, etc.), predetermined time periods, operational periods, and/or any other suitable inputs.

At step 308, one or more production nodes within the target network are optimized for one or more target parameters over one or more predetermined time periods. For example, in some embodiments, the one or more production nodes are optimized for one or more target parameters including production option (e.g., what final resource is to be generated from available initial resources), quantity (e.g., how much final resource is to be generated), production sources (e.g., which production unit (e.g., line) of a production node is to be utilized to process the initial resources), production time frame (e.g., when is the initial resource to be processed), production sequencing (e.g., in what order are selected production options to be executed for a given time frame and/or a given production node/sub-portion of a production node), etc. The production time frame may include a rolling window including a set of predetermined time periods. Optimization of the target network may be executed by any suitable process, engine, module, etc., such as, for example, the network optimization engine 358.

In some embodiments, the network optimization engine 358 is configured to implement one or more genetic optimization processes. A genetic optimization process may include one or more layers each configured to optimize for one or more target parameters. Each of the optimization layers may be implemented as trained model (e.g., a trained machine learning model), an algorithmic module, and/or any other suitable process. In some embodiments, the network optimization engine 358 implements a set of stacked optimization layers including at least a first layer configured to optimize one or more target parameters and a second layer configured to receive an output of the first layer and optimize one or more additional target parameters.

In some embodiments, the network optimization engine 358 implements a first layer configured to optimize each of a production option, quantity, production source, and production time frame for a selected production node. The first layer may include a first optimization formulation, such as, for example:

xₜ^{i,o}=P

where P is the total production to be generated of option o on sub-portion (e.g., line) l over timeframe t. An optimization solution (e.g., a value of x) may be obtained by the first layer. The total number of potential variables is equal to the number of options times the number of sub-portions times the number of time frames available, e.g., n(l)*n(o)*n(t). The first layer may implement an optimization solution including a total production including a lower bound equal to zero and an upper bound equal to an inventory size for each option within a given time frame. The total production variable may be defined as discrete variable having two or more incremental values to reduce computational complexity.

In some embodiments, a first layer implemented by the network optimization engine 358 is configured to apply an objective function to maximize an adherence percentage with respect to the total production of a selected production node. The objective function may be maximized with respect to an adherence percentage where a demand of product p at timeframe t is Dₜ^{P}, the corresponding production supply is Sₚ^{t}, and the product p satisfies an “adherence” requirement for the timeframe t if the ratio of supply and demand is within a predetermined percentage, e.g.:

$${L}_{L} \leq \frac{{S}_{p}^{t}}{{D}_{p}^{t}} \leq {L}_{u}$$

where L_{L} is the lower acceptable limit and L_{U} is the upper acceptable limit of production. In one non-limiting example, L_{L}=0.9 and L_{U}=1.2. Although specific embodiments are discussed herein, it will be appreciated that any suitable upper and/or lower limits may be used. In some embodiments, the first layer implemented by the network optimization engine 358 is configured to apply an OTIF constraint. The OTIF constraint may include a constraint for each timeframe t. For example, an OTIF constraint may be defined as a period OTIF percentage, where:

$$Periodic OTIF \% = \frac{{\sum }_{p} {S}_{t}^{p}}{{\sum }_{p} {D}_{t}^{p}} \leq 100 \%$$

for each time period t.

In some embodiments, one or more additional constraints may be implemented with respect to optimization at a first layer implemented by the network optimization engine 358. For example, in some embodiments, a production capacity for each sub-unit (e.g., line) within a production node may vary. Production capacity may be impacted by scheduled and/or unscheduled downtime for a corresponding sub-unit, changeover time for converting a sub-unit from producing a first finished product to producing a second finished product, and/or other events impacting production. As another example, in some embodiments, one or more additional constraints may included production and supply rules, such as, for example, requirements that a finished product be completed and transported prior to a corresponding demand period for the finished product, a predetermined storage period for products, a shelf-life for finished products, etc.

In some embodiments, the network optimization engine 358 implements a second layer. The second layer is configured to receive one or more inputs from the first layer corresponding to optimal solutions for one or more target parameters. For example, in some embodiments, the second layer is configured to receive optimal solutions from the first layer for one or more target parameters including a production option, quantity, production source, and production time frame for a selected production node. The second layer may be configured to generate an optimal solution for one or more additional target parameters. For example, to continue the prior example, a second layer configured to receive optimal solutions for a production option, quantity, production source, and production time frame for a selected production node may be configured to generate an optimal sequence for operation of a corresponding production line to generate the quantity of finished resources as determined by the first layer.

In some embodiments, the second layer is configured to optimize an objective function to minimize total downtime (e.g., changeover time) of a corresponding sub-portion of a production node. The objective function may apply one or more constraints, such as, for example, an operational priority for one or more production periods. The complexity of the objective function of the second layer may be dependent on the number of options that may be provided for each sub-node of a production node, e.g., Complexity=x!, where x is the number of options for a sub-node. As one non-limiting example, a sub-node including five options (e.g., an option to generate one of five finished resources) may have 120 (e.g., 5!) potential sequences.

In some embodiments, a multilayer genetic optimization process provides a multilayer combinatorial optimization configured to identify a production sequence (e.g., schedule) for the corresponding target production node that maximizes adherence for all final resources from the corresponding target production node over a predetermined number of time periods. In some embodiments, the genetic optimization process provides a three-dimensional solution such that production for a target production node 90 is optimized for each predetermined time period, across each sub-node of the target production node, and for all potential options (e.g., configurations) of each sub-node. The genetic optimization process may be configured to optimize for solutions having multiple variables that cannot be optimized without the assistance of the genetic optimization process, such as, for example, systems having hundreds and/or thousands of variables.

At step 310, an optimized production data structure 370 is output. The optimized production data structure 370 includes an optimal sequence plan for each of the sub-nodes of a target production node to optimized production of the target production node in view of the provided constraints. The optimized production data structure 370 may include sub-node production sequences for one or more predetermined time frames optimized to meet demand of each finished resource within a target network (e.g., a portion of a production network serviced by the target production node). The optimized production data structure 370 may be used in one or more additional processes, such as one or more automation processes, scheduling processes, simulation processes, planning processes, etc.

In some embodiments, the disclosed systems and methods provide for optimization of target networks to reduce per unit final resource production cost and time while still meeting network demand through optimal production. Optimized production data structures 370 increase productivity through capacity utilization of target production node resources. The generated optimized production data structure(s) 370 may be used for further resource and/or network planning.

In some embodiments, an optimization interface may be generated including at least a portion of the optimized production data structure 370. The optimization interface may further optionally include interface elements representative of the network data 354 and/or the parameter data 356. The optimization interface may be configured to provide interface elements representative of, but not limited to, initial material availability, production capacity, final resource production rates, final resource production yields, etc.

As one non-limiting example, in some embodiments, a target processing node may simulate operation of a processing facility configured to convert initial resources including perishable raw materials (e.g., plants, animals, etc.) into final resources suitable for sale, such as a production facility configured to receive whole animals and generate cuts or other portions of meat for sale. The target processing node may include a node parameter defining a set of discrete time slots for each day configured to simulate shifts or processing periods operated at the simulated processing facility. The set of discrete time periods may be defined as [symbol] with t being an index of time in days such that t∈ [symbol] ={1, 2, . . . , T}, where T is the total number of production days during which the target processing node is to be simulated.

The target processing node may include an additional node parameter defining a set of production lines, [symbol] , where l is an index for the production lines (e.g., sub-nodes of the target production node) such that l∈ [symbol] ={1, 2, . . . , L}, where L is the total number of production lines. A set of distinct types of final resources (e.g., products or cuts) [symbol] and a set of distinct types of initial and/or residual resources [symbol] may define a set of production options [symbol] , where [symbol] includes each option available to convert an initial and/or residual resource into a final resource. The options [symbol] include an index o, such that o∈ [symbol] ={1, 2, . . . , N} where N is the total number of possible options. Each option in the set of options O may be associated with a weight in a set of weights [symbol] having an index k such that ∈ [symbol] ={0,1,2, . . . , K} where K is the total number of discretization levels for weight choices.

In some embodiments, one or more functions may be predefined for the target processing node. For example, one or more node parameters may define the one or more functions. The set of predefined functions may include, but are not limited to: [symbol] _{BOM}, a mapping function configured to estimate how much initial and/or residual resource is processed and how much of a final resource is produced based on one or more inputs (e.g., BOM inputs); [symbol] _{CO}, a mapping function configured to estimate change over time for each sub-node of the target production node; [symbol] _{prod}, a mapping function configured to estimate production time for each final resource; and [symbol] ₒₚₜ, a mapping function configured to get an index of selected options in a production line. Although specific embodiments are discussed herein, it will be appreciated that any suitable functions may be defined and/or utilized for simulation of a target processing node.

In some embodiments, a multilayer genetic optimization process may have one or more defined parameters that may be utilized and/or adjusted for optimization of the target production node. The set of parameters may include, but is not limited to: xₜ^{l,o}, a quantity of an option o that can be processed by a line l on a given day t such that xₜ^{l,o}∈ [symbol] ; xₜ^{l}, a quantity of all options o∈ [symbol] for a line l at day t to be processed, where xₜ^{l}=[xₜ^{l,1},xₜ^{l,2}, . . . , xₜ^{l,N}]^{T}; x, a quantity of all options o∈ [symbol] for all lines l∈ [symbol] and for all days ∈ [symbol] , such that x∈ [symbol] ^{T×L×N} defines a decision variable for x; Dₜ^{p}, a demand for product p∈ [symbol] at day t; Qₜ^{p}, and inventory quantity for product p∈ [symbol] at the end of day t; Qₜ^{s}, and inventory quantity for initial and/or residual resources s∈ [symbol] at the end of day t; yₜ^{s,l} and yₜ^{p,l}, a quantity of initial and/or residual resources, s, to be used and product p to be produced at line l in day t such that [symbol] _{BOM} may be defined as [symbol] _{BOM}(xₜ^{l})=[yₜ^{s,l},yₜ^{p,l}]∀S∈ [symbol] , p∈ [symbol] , l∈ [symbol] , t∈ [symbol] ; H_{t,down}^{l}, an estimated downtime (in hours) for line l at day t; H_{CO}^{o,o}′ and estimated changeover time (in hours) between options o and o′; H_{CO}, a changeover time matrix for all options where H_{CO}=[[H_{CO}^{o,o′}]]∀o,o′∈ [symbol] ; H_{t,CO}^{l}, an estimated total change over time (in hours) for line l at day t such that H_{t,CO}^{l}= [symbol] _{CO}(xₜ^{l},H_{CO}); H_{t,shift}, a total shift hours available for every day t, and/or H_{t,prod}^{l}, a total production hours estimated for every day t and line l. H_{t,prod}^{l}= [symbol] _{prod}(xₜ^{l}). Although specific embodiments are discussed herein, it will be appreciated that any suitable parameters may be received and/or defined.

In some embodiments, an indicator variable lₜ^{p}(x) may be defined to denote adherence of a product p for a demand at day t, where:

$${I}_{t}^{p} ( x ) = \{ \begin{matrix}1 & if 0.9 * {D}_{t}^{p} \leq {Q}_{t - 3}^{p} + {y}_{t - 2}^{p} \leq 1.2 * {D}_{t}^{p} \\ 0 & otherwise\end{matrix} ;$$

Qₜ₋₃^{p}+yₜ₋₂^{p} is the amount of product p at the end of day t−2 production. The objective function of a first layer of a multilayer genetic optimization process may be configured to maximize adherence with respect to x such that:

$${max}_{x} [ {\sum }_{t ∈ 𝒯} {\sum }_{p ∈ {𝒫}_{t}} {I}_{t}^{p} ( x ) / {\sum }_{t ∈ 𝒯} \vert {𝒫}_{t} \vert ]$$

The objective function may utilize one or more constraints, such as an OTIF constraint, where:

$$OTIF = \frac{{\sum }_{p ∈ {𝒫}_{t}} {Q}_{t - 3}^{p} + {y}_{t - 2}^{p}}{{\sum }_{p ∈ {𝒫}_{t}} {D}_{t}^{p}} \leq 1 ∀ t ∈ 𝒯$$

$${H}_{t , prod}^{l} + {H}_{t , down}^{l} + {H}_{t , CO}^{l} \leq {H}_{t , shift} ∀ t ∈ 𝒯 , l ∈ ℒ$$

with [symbol] ₜ⊆ [symbol] being a set of all products that has demand at day t. The OTIF may be constrained to be less than or equal to 100% and/or the total daily production hours for each line is less than a sum of the total available shift time, down time, and/or changeover time.

In some embodiments, a second layer of a multilayer genetic optimization process may include an objective function configured to minimize a total changeover time H_{t,CO}^{l} for each line l for each day t with a given xₜ^{l} from the first layer of the multilayer genetic optimization process, e.g.:

$${min}_{{y}_{t}^{l}} {H}_{t , CO}^{l} ( {y}_{t}^{l} ) for all l ∈ ℒ , t ∈ 𝒯$$

In some embodiments, yₜ^{l} is a ranking decision vector which comes from various permutations of the selected options [symbol] ₒₚₜ(xₜ^{l}) for a given line and day, such that [symbol] ₒₚₜ(xₜ^{l})={o:xₜ^{l,o}>0}. The second layer may utilize one or more constraints, such as sequencing production of high priority products earlier in a production sequence. In some embodiments, the second layer of the multilayer genetic optimization process determines an optimal sequence of scheduled options for the target production node. Each line may be processed independently for each day with the objective of minimizing change over time. Additional constraints may be applied at the second layer, such as, for example, an expiry constraint, available inventory constraint, etc.

Various disclosed embodiments include and/or utilize a genetic algorithm, such as a genetic optimization process as discussed above. As used herein, the term genetic optimization (or genetic algorithm) refers to one or more algorithms configured to utilize a process similar to natural selection to generate high-quality solutions to optimization and/or search problems. Genetic algorithms rely on biologically inspired operators such as mutation, crossover, and selection operators. In operation, a genetic algorithm may generate a population of candidate solutions, with each candidate solution having a set of properties. The properties of the population of candidate solutions may be modified (e.g., evolved) in an iterative generation creation process. For each subsequent generation, the fitness (e.g., a qualitative representation of success) is evaluated, for example, based on the value of an objective function in the optimization problem being solved.

In some embodiments, a genetic algorithm may include an initialization phase in which a population of candidate solutions is generated. The population size may be adjusted based on the optimization process to be address, but may include hundreds or thousands of potential solutions. The initial set of candidate solutions may be referred to as a search space. A portion of the initial population is selected for reproduction based on a fitness-based (e.g., objective function based) determination as to which of candidate solutions are reproduced. A subsequent generation of candidate solutions is generated from the portion of the initial population selected for reproduction by randomly selecting a pair of “parent” solutions that are combined by applying one or more genetic operators. Genetic operators may include, but are not limited to, crossover, mutation, regrouping, colonization-extinction, migration, etc. In some embodiments, heuristic processes may be employed to encourage population diversity and prevent early convergence to less-than-optimal solutions.

A genetic optimization process may continue generating subsequent generations in an iterative process until one or more termination conditions have been met. Termination conditions may include, but are not limited to, satisfaction of a minimum criteria, a fixed number of generations are created, an allocated time period and/or processing period has been reached, the highest ranking solution fitness is substantially constant over multiple generations, etc. When the genetic optimization process terminates, the most fit (e.g., highest ranking by objective function) solution is output as the solution to the genetic optimization problem.

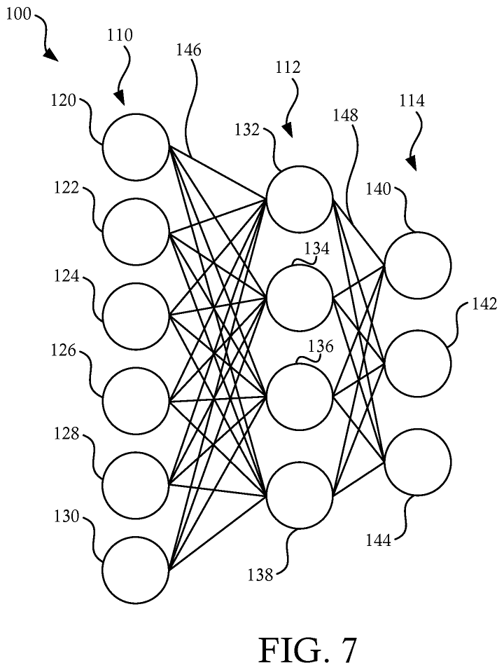

FIG. 7 illustrates an artificial neural network 100, in accordance with some embodiments. Alternative terms for “artificial neural network” are “neural network,” “artificial neural net,” “neural net,” or “trained function.” The neural network 100 comprises nodes 120-144 and edges 146-148, wherein each edge 146-148 is a directed connection from a first node 120-138 to a second node 132-144. In general, the first node 120-138 and the second node 132-144 are different nodes, although it is also possible that the first node 120-138 and the second node 132-144 are identical. For example, in FIG. 7 the edge 146 is a directed connection from the node 120 to the node 132, and the edge 148 is a directed connection from the node 132 to the node 140. An edge 146-148 from a first node 120-138 to a second node 132-144 is also denoted as “ingoing edge” for the second node 132-144 and as “outgoing edge” for the first node 120-138.

The nodes 120-144 of the neural network 100 may be arranged in layers 110-114, wherein the layers may comprise an intrinsic order introduced by the edges 146-148 between the nodes 120-144 such that edges 146-148 exist only between neighboring layers of nodes. In the illustrated embodiment, there is an input layer 110 comprising only nodes 120-130 without an incoming edge, an output layer 114 comprising only nodes 140-144 without outgoing edges, and a hidden layer 112 in-between the input layer 110 and the output layer 114. In general, the number of hidden layer 112 may be chosen arbitrarily and/or through training. The number of nodes 120-130 within the input layer 110 usually relates to the number of input values of the neural network, and the number of nodes 140-144 within the output layer 114 usually relates to the number of output values of the neural network.

In particular, a (real) number may be assigned as a value to every node 120-144 of the neural network 100. Here, xᵢ⁽ⁿ⁾ denotes the value of the i-th node 120-144 of the n-th layer 110-114. The values of the nodes 120-130 of the input layer 110 are equivalent to the input values of the neural network 100, the values of the nodes 140-144 of the output layer 114 are equivalent to the output value of the neural network 100. Furthermore, each edge 146-148 may comprise a weight being a real number, in particular, the weight is a real number within the interval [−1, 1], within the interval [0, 1], and/or within any other suitable interval. Here, w_{i,j}^{(m,n)} denotes the weight of the edge between the i-th node 120-138 of the m-th layer 110, 112 and the j-th node 132-144 of the n-th layer 112, 114. Furthermore, the abbreviation w_{i,j}⁽ⁿ⁾ is defined for the weight w_{i,j}^{(n,n+1)}.

In particular, to calculate the output values of the neural network 100, the input values are propagated through the neural network. In particular, the values of the nodes 132-144 of the (n+1)-th layer 112, 114 may be calculated based on the values of the nodes 120-138 of the n-th layer 110, 112 by

$${x}_{j}^{( n + 1 )} = f ( {\sum }_{i} {x}_{i}^{( n )} \cdot {w}_{i , j}^{( n )} )$$

Herein, the function f is a transfer function (another term is “activation function”). Known transfer functions are step functions, sigmoid function (e.g., the logistic function, the generalized logistic function, the hyperbolic tangent, the Arctangent function, the error function, the smooth step function) or rectifier functions. The transfer function is mainly used for normalization purposes.

In particular, the values are propagated layer-wise through the neural network, wherein values of the input layer 110 are given by the input of the neural network 100, wherein values of the hidden layer(s) 112 may be calculated based on the values of the input layer 110 of the neural network and/or based on the values of a prior hidden layer, etc.

In order to set the values w_{i,j}^{(m,n)} for the edges, the neural network 100 has to be trained using training data. In particular, training data comprises training input data and training output data. For a training step, the neural network 100 is applied to the training input data to generate calculated output data. In particular, the training data and the calculated output data comprise a number of values, said number being equal with the number of nodes of the output layer.

In particular, a comparison between the calculated output data and the training data is used to recursively adapt the weights within the neural network 100 (backpropagation algorithm). In particular, the weights are changed according to

$${w}_{i , j}^{′ ( n )} = {w}_{i , j}^{( n )} - γ \cdot {δ}_{j}^{( n )} \cdot {x}_{i}^{( n )}$$

wherein γ is a learning rate, and the numbers δⱼ⁽ⁿ⁾ may be recursively calculated as

$${δ}_{j}^{( n )} = ( {\sum }_{k} {δ}_{k}^{( n + 1 )} \cdot {w}_{j , k}^{( n + 1 )} ) \cdot {f}^{′} ( {\sum }_{i} {x}_{i}^{( n )} \cdot {w}_{i , j}^{( n )} )$$

based on δⱼ⁽ⁿ⁺¹⁾, if the (n+1)-th layer is not the output layer, and

$${δ}_{j}^{( n )} = ( {x}_{k}^{( n + 1 )} - {t}_{j}^{( n + 1 )} ) \cdot {f}^{′} ( {\sum }_{i} {x}_{i}^{( n )} \cdot {w}_{i , j}^{( n )} )$$

if the (n+1)-th layer is the output layer 114, wherein f′ is the first derivative of the activation function, and yⱼ⁽ⁿ⁺¹⁾ is the comparison training value for the j-th node of the output layer 114.

In some embodiments, the neural network 100 is configured, or trained, to optimize one or more components and/or elements of a production node and/or sub-node. For example, in some embodiments, the neural network 100 is configured to optimize an objective function at one or more layers of a network optimization engine 358.

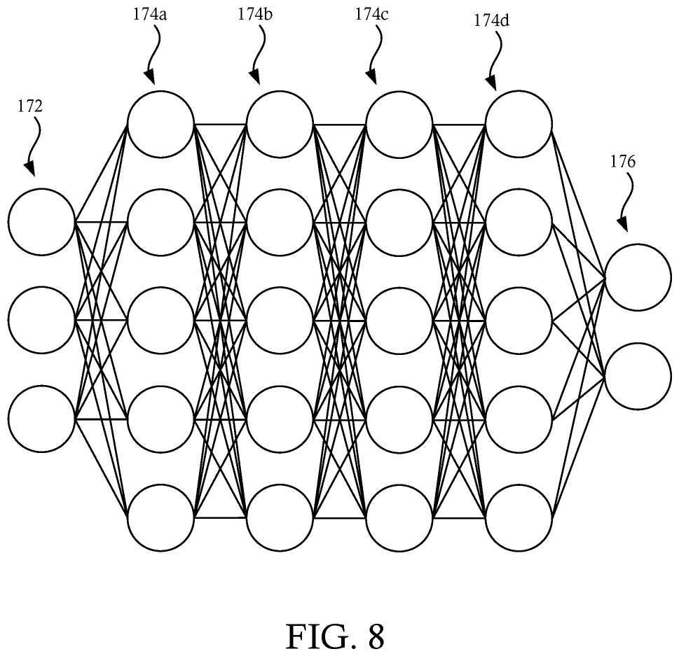

FIG. 8 illustrates a deep neural network (DNN) 170, in accordance with some embodiments. The DNN 170 is an artificial neural network, such as the neural network 100 illustrated in conjunction with FIG. 7, that includes representation learning. The DNN 170 may include an unbounded number of (e.g., two or more) intermediate layers 174a-174d each of a bounded size (e.g., having a predetermined number of nodes), providing for practical application and optimized implementation of a universal classifier. Each of the layers 174a-174d may be heterogenous. The DNN 170 may be configured to model complex, non-linear relationships. Intermediate layers, such as intermediate layer 174c, may provide compositions of features from lower layers, such as layers 174a, 174b, providing for modeling of complex data.

In some embodiments, the DNN 170 may be considered a stacked neural network including multiple layers each configured to execute one or more computations. The computation for a network with L hidden layers may be denoted as:

$$f ( x ) = f [ {a}^{( L + 1 )} ( {h}^{( L )} ( {a}^{( L )} ( ... ( {h}^{( 2 )} ( {a}^{( 2 )} ( {h}^{( 1 )} ( {a}^{( 1 )} ( x ) ) ) ) ) ) ) ) ]$$

where α^{(l)}(x) is a preactivation function and h^{(l)}(x) is a hidden-layer activation function providing the output of each hidden layer. The preactivation function α^{(l)}(x) may include a linear operation with matrix W^{(l)} and bias b^{(l)} where:

$${a}^{( l )} ( x ) = {W}^{( l )} x + {b}^{( l )}$$

In some embodiments, the DNN 170 is a feedforward network in which data flows from an input layer 172 to an output layer 176 without looping back through any layers. In some embodiments, the DNN 170 may include a backpropagation network in which the output of at least one hidden layer is provided, e.g., propagated, to a prior hidden layer. The DNN 170 may include any suitable neural network, such as a self-organizing neural network, a recurrent neural network, a convolutional neural network, a modular neural network, and/or any other suitable neural network.

In some embodiments, a DNN 170 may include a neural additive model (NAM). An NAM includes a linear combination of networks, each of which attends to (e.g., provides a calculation regarding) a single input feature. For example, a NAM may be represented as:

$$y = β + {f}_{1} ( {x}_{1} ) + {f}_{2} ( {x}_{2} ) + … + {f}_{K} ( {x}_{K} )$$

where β is an offset and each fᵢ is parametrized by a neural network. In some embodiments, the DNN 170 may include a neural multiplicative model (NMM), including a multiplicative form for the NAM mode using a log transformation of the dependent variable y and the independent variable x:

y=e^{β}e^{f(log x)}e^{Σif}^{ᵢ}^{d(d}^{ᵢ}⁾

where d represents one or more features of the independent variable x.

In some embodiments, the deep neural network 170 is configured, or trained, to optimize one or more components and/or elements of a production node and/or sub-node. For example, in some embodiments, the deep neural network 170 is configured to optimize an objective function at one or more layers of a network optimization engine 358.

It will be appreciated that production node optimization as disclosed herein, particularly on large networks utilizing the disclosed objective functions, is only possible with the aid of computer-assisted processes, such as machine-learning algorithms and techniques. In some embodiments, machine learning processes are used to perform operations that cannot practically be performed by a human, either mentally or with assistance, such as optimization of one or more variables based on one or more objective functions. It will be appreciated that a variety of machine learning techniques can be used alone or in combination to generate optimize production values and/or variable values for a target network and/or target node.

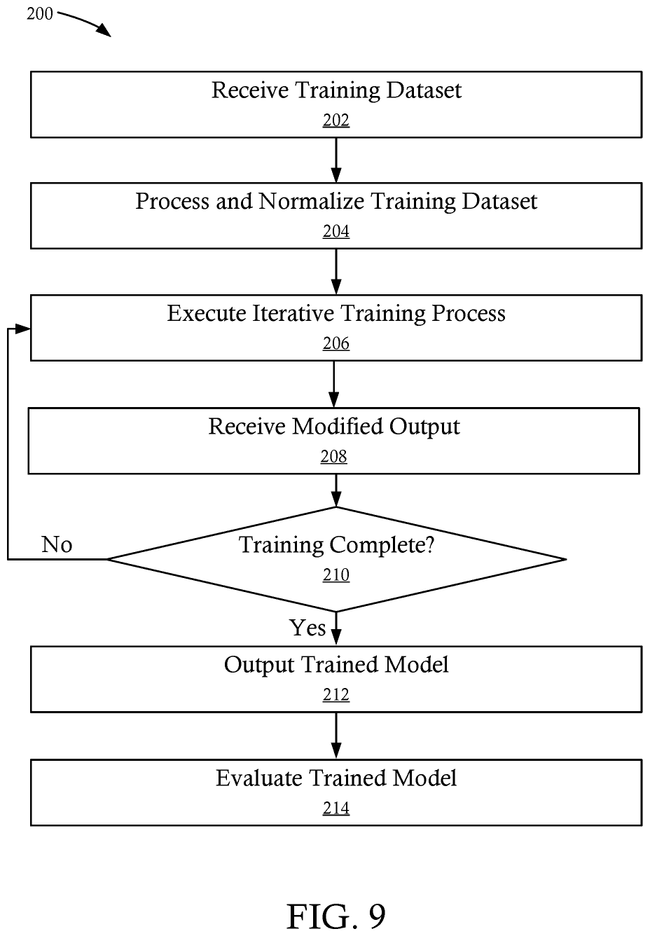

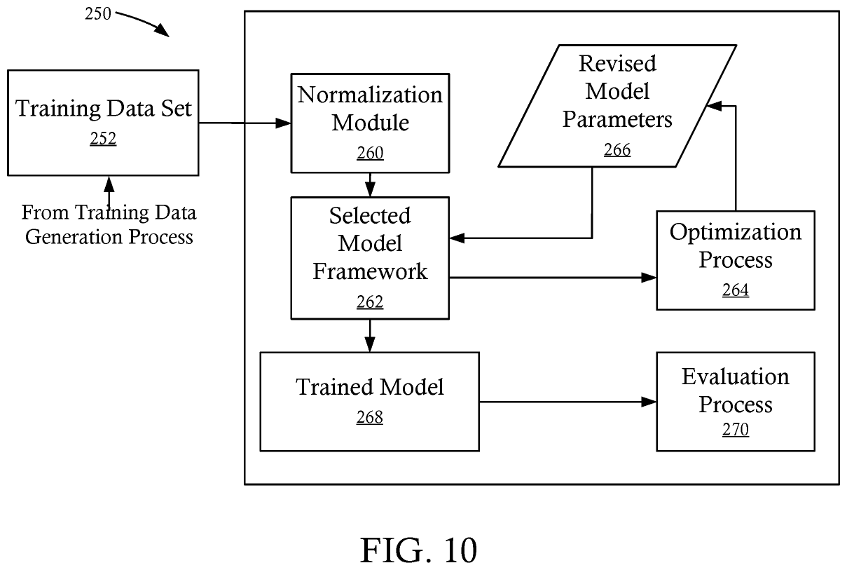

In some embodiments, one or more trained models can be generated using an iterative training process based on a training dataset. FIG. 9 illustrates a method 200 for generating a trained model, such as a trained optimization model, in accordance with some embodiments. FIG. 10 is a process flow 250 illustrating various steps of the method 200 of generating a trained model, in accordance with some embodiments. At step 202, a training dataset 252 is received by a system, such as a processing device 10. The training dataset 252 can include labeled and/or unlabeled data.

At optional step 204, the received training dataset 252 is processed and/or normalized by a normalization module 260. For example, in some embodiments, the training dataset 252 can be augmented by imputing or estimating missing values of one or more features associated with production node optimization models. In some embodiments, processing of the received training dataset 252 includes outlier detection configured to remove data likely to skew training of a production node optimization model. In some embodiments, processing of the received training dataset 252 includes removing features that have limited value with respect to training of the production node optimization model.

At step 206, an iterative training process is executed to train a selected model framework 262. The selected model framework 262 can include an untrained (e.g., base) machine learning model and/or a partially or previously trained model (e.g., a prior version of a trained model). The training process is configured to iteratively adjust parameters (e.g., hyperparameters) of the selected model framework 262 to minimize a cost value (e.g., an output of a cost function) for the selected model framework 262. In some embodiments, the cost value is related to optimization of one or more target parameters of a target node and/or sub-node.

The training process is an iterative process that generates set of revised model parameters 266 during each iteration. The set of revised model parameters 266 can be generated by applying an optimization process 264 to the cost function of the selected model framework 262. The optimization process 264 can be configured to reduce the cost value (e.g., reduce the output of the cost function) at each step by adjusting one or more parameters during each iteration of the training process.

After each iteration of the training process, at step 208, a determination is made whether the training process is complete. The determination at step 208 can be based on any suitable parameters. For example, in some embodiments, a training process can complete after a predetermined number of iterations. As another example, in some embodiments, a training process can complete when it is determined that the cost function of the selected model framework 262 has reached a minimum, such as a local minimum and/or a global minimum.

At step 210, a trained model 268, such as a trained production node optimization model, is output and provided for use in production network optimization, as discussed above. At optional step 212, a trained model 268 can be evaluated by an evaluation process 270. A trained model can be evaluated based on any suitable metrics, such as, for example, an F or F1 score, normalized discounted cumulative gain (NDCG) of the model, mean reciprocal rank (MRR), mean average precision (MAP) score of the model, and/or any other suitable evaluation metrics. Although specific embodiments are discussed herein, it will be appreciated that any suitable set of evaluation metrics can be used to evaluate a trained model.

Although the subject matter has been described in terms of exemplary embodiments, it is not limited thereto. Rather, the appended claims should be construed broadly, to include other variants and embodiments, which may be made by those skilled in the art.

What is claimed is:

1. A system, comprising:
a non-transitory memory;
a processor communicatively coupled to the non-transitory memory, wherein the processor is configured to read a set of instructions to:
receive an optimization request identifying a target production node;
implement an optimization engine configured to optimize a sequence of operation for one or more sub-nodes of the target production node utilizing an objective function configured to maximize an adherence percentage; and
output an optimized production data structure including the optimized sequence of operation of the one or more sub-nodes of the target production node.

2. The system of claim 1, wherein the objective function is configured to optimize a plurality of parameters including a final resource type, a final resource quantity, a production timeframe, and a sub-node selection.

3. The system of claim 2, wherein the objective function is optimized by a multilayer optimization process including a first layer configured to optimize the plurality of parameters and a second layer configured to receive optimized values for the plurality of parameters and generate the optimized sequence of operation.

4. The system of claim 1, wherein the objective function is configured to optimize an on-time in-full (OTIF) percentage.

5. The system of claim 4, wherein the OTIF percentage includes a ratio of predicted supply to predicted demand for one or more production timeframes.

6. The system of claim 1, wherein the optimization engine includes a first layer configured to optimize a first subset of parameters and a second layer configured to optimize a second subset of parameters.

7. The system of claim 6, wherein the second layer is configured to receive an optimized value for each of the first subset of parameters from the first layer.

8. The system of claim 6, wherein the first layer is configured to apply a first objective function and the second layer is configured to apply a second objective function different than the first objective function.

9. A computer-implemented method, comprising:
receiving an optimization request identifying a target production node;
implementing an optimization engine configured to optimize a sequence of operation for one or more sub-nodes of the target production node utilizing an objective function configured to maximize an adherence percentage; and
outputting an optimized production data structure including the optimized sequence of operation of the one or more sub-nodes of the target production node.

10. The computer-implemented method of claim 9, wherein the objective function is configured to optimize a plurality of parameters including a final resource type, a final resource quantity, a production timeframe, and a sub-node selection.

11. The computer-implemented method of claim 10, wherein the objective function is optimized by a multilayer optimization process including a first layer configured to optimize the plurality of parameters and a second layer configured to receive optimized values for the plurality of parameters and generate the optimized sequence of operation.

12. The computer-implemented method of claim 9, wherein the objective function is configured to optimize an on-time in-full (OTIF) percentage.

13. The computer-implemented method of claim 12, wherein the OTIF percentage includes a ratio of predicted supply to predicted demand for one or more production timeframes.

14. The computer-implemented method of claim 9, wherein the optimization engine includes a first layer configured to optimize a first subset of parameters and a second layer configured to optimize a second subset of parameters.

15. The computer-implemented method of claim 14, wherein the second layer is configured to receive an optimized value for each of the first subset of parameters from the first layer.

16. The computer-implemented method of claim 14, wherein the first layer is configured to apply a first objective function and the second layer is configured to apply a second objective function different than the first objective function.

17. A non-transitory computer readable medium having instructions stored thereon, wherein the instructions, when executed by at least one processor, cause at least one device to perform operations comprising:
receiving an optimization request identifying a target production node;
implementing an optimization engine configured to optimize a sequence of operation for one or more sub-nodes of the target production node utilizing an objective function configured to maximize an adherence percentage, wherein the objective function is configured to optimize a plurality of parameters including a final resource type, a final resource quantity, a production timeframe, and a sub-node selection; and
outputting an optimized production data structure including the optimized sequence of operation of the one or more sub-nodes of the target production node.

18. The non-transitory computer readable medium of claim 17, wherein the objective function is optimized by a multilayer optimization process including a first layer configured to optimize the plurality of parameters and a second layer configured to receive optimized values for the plurality of parameters and generate the optimized sequence of operation.

19. The non-transitory computer readable medium of claim 17, wherein the objective function is configured to optimize an on-time in-full (OTIF) percentage including a ratio of predicted supply to predicted demand for one or more production timeframes.

20. The non-transitory computer readable medium of claim 17, wherein the optimization engine includes a first layer configured to optimize a first subset of parameters and a second layer configured to optimize a second subset of parameters, wherein the second layer is configured to receive an optimized value for each of the first subset of parameters from the first layer, and wherein the first layer is configured to apply a first objective function and the second layer is configured to apply a second objective function different than the first objective function.
